(19) United States
(12) Patent Application Publication
(10) Pub. No.: US 2014/0000553 A1
(43) Pub. Date: Jan. 2, 2014

(54) METHOD OF OPERATING AN INTERNAL COMBUSTION ENGINE

(71) Applicant: DAIMLER AG, Stuttgart (DE)

(72) Inventors: Torsten DIELER, Stuttgart (DE); Dirk HAASE, Leutenbach (DE); Ruediger HERWEG, Esslingen (DE)

(73) Assignee: DAIMLER AG, Stuttgart (DE)

(21) Appl. No.: 13/858,013

(22) Filed: Apr. 6, 2013

(30) Foreign Application Priority Data
Oct. 7, 2010 (DE) 10 2010 047 795.8

(51) Int. Cl. F02B 17/00

(52) U.S. Cl. CPC F02B 17/005
USPC 123/295

(57) ABSTRACT

An operating mode of an internal combustion engine, in particular a directly injected internal combustion engine featuring a plurality of combustion chambers, in particular for a direct-injection gasoline engine for a motor vehicle, an operating mode having at least in part low-NOx combustion (NAV) and having a plurality of partial operating modes wherein it is switched between another partial operating mode and a NAV partial operating mode, wherein in the case of said NAV partial operating mode, at an ignition point (ZZP) a largely homogeneous, lean fuel/exhaust gas/air mixture having a combustion air ratio of λ≧1 is spark ignited in the respective combustion chamber by means of an ignition device, and where a flame front combustion (FFV) initiated by the spark-ignition transitions to a controlled auto-ignition (RZV).

The operational stability of the respective partial operating mode can be improved by variation of the compression ratio ε.

### CROSS-REFERENCE TO RELATED APPLICATION

This is a continuation-in-part application of pending international application PCT/EP2011/005002 filed Oct. 7, 2011 and claiming the priority of German Application No. 10 2010 047 795.8 filed Oct. 7, 2010.

### BACKGROUND OF THE INVENTION

The present invention describes an operating mode of an internal combustion engine. In particular, for a reciprocating piston engine, for example a gasoline engine having direct injection, in a motor vehicle, said piston engine having low-NOx combustion (NAV).

Downsizing can be used in the automotive engineering sector, in addition to other measures, in order to reduce CO₂ emissions. In this context downsizing means constructing, employing and operating small-displacement engines in such a way that they achieve equivalent or better rankings with respect to driving behaviour when compared to their predecessor large-displacement engines. Downsizing allows fuel consumption to be reduced and thus CO₂ emissions to be lowered. In addition, engines with smaller displacements have lower absolute frictional losses.

Smaller displacement engines are, however, characterised by having lower torque, especially at low speeds, leading to the vehicle having a poorer dynamic response and thus reduced flexibility. Disadvantages associated with the downsizing of gasoline engines can be largely compensated for through appropriate operating modes.

An operating mode is known from EP 1 543 228 B1 wherein, for example, a lean fuel/exhaust gas/air mixture in the combustion chamber of the internal combustion engine is caused to auto-ignite. In order that compression ignition occurs at the desired time, fuel is injected into the lean, homogeneous fuel/exhaust gas/air mixture in the combustion chamber at the appropriate compression shortly before being spark ignited, so that a richer fuel-air mixture is formed. Embedded in the lean, homogeneous fuel/exhaust gas/air mixture, this concentrated fuel-air mixture serves as the initiator for compression-ignited combustion in the combustion chamber.

DE102006041467A1 contains a description for an operating mode for a gasoline engine with homogeneous, compression-ignited combustion. If the homogeneous fuel/exhaust gas/air mixture, said mixture being a lean mixture, is compressed, in contrast to the otto-cycle operating mode, combustion does not spread in the combustion chamber as a flame front combustion originating from the point of ignition, but instead at an appropriate compression level the homogeneous fuel/exhaust gas/air mixture ignites at several points in the respective combustion chamber almost simultaneously, so that in this case controlled auto-ignition sets in. Controlled auto-ignition (RZV) exhibits significantly lower nitrogen oxide emissions along with high efficiency in terms of fuel consumption compared to the spark-ignition otto-cycle operation modes. This low-emission, efficient RZV operating mode with controlled auto-ignition can, however, only be used at a lower and possibly medium engine load/engine speed range, as knocking tendency increases with decreasing charge dilution, and thus the useful application of the RZV operating mode in higher engine load ranges is limited.

An operating mode for an internal combustion engine is known from DE10350798A1, wherein it, is switched between at least one spark-ignited and at least one compression-ignited partial operating mode. The compression ratio ε is changed when switching between a spark-ignited and a compression-ignited partial operating mode. A compression-ignited partial operating mode is characterised by a high ε whereas a spark-ignition partial operating mode is characterised by a low compression ratio ε. By adjusting the compression ratio ε for the respective partial operating mode, an efficiency-optimised operation is made possible in both auto-ignition mode and spark-ignition mode.

The present invention is concerned with the problem of providing an improved or at least an alternative embodiment for an operating mode for an internal combustion engine that is characterised by an improved overall strategy, in particular with regard to NOx emission values and fuel consumption. According to the invention, this problem is solved by the subject-matter of the independent claim. Advantageous embodiments are the subject matter of the dependent claims.

### SUMMARY OF THE INVENTION

Hence the invention is based on the general idea, as part of an operating mode for an internal combustion engine, in particular a directly injected internal combustion engine featuring a plurality of combustion chambers, in particular for a direct-injection gasoline engine, for example in a motor vehicle, said operating mode having at least in part low-NOx combustion (NAV) and having a plurality of partial operating modes, to switch between a NAV partial operating mode and at least one other partial operating mode, wherein in the case of said NAV partial operating mode at an ignition point (ZZP), a largely homogeneous, lean fuel/exhaust gas/air mixture having a combustion air ratio of λ>1 is spark ignited by means of an ignition device in the respective combustion chamber, wherein the flame front combustion (FFV) initiated by the spark-ignition transitions to a controlled auto-ignition (RZV).

Advantageous for such an overall strategy is the ability to perform a controlled auto-ignition (RZV) over a wide range of operating conditions and at least in one low and in one medium engine load range, so that in the case of the particular operating mode having controlled auto-ignition, the fuel consumption is reduced as are the NOx emission values in comparison with a otto-cycle partial operating mode.

In an alternative embodiment, the DES partial operating mode can be implemented in place of the RZV partial operating mode at a low and medium engine load range.

An internal combustion engine, in particular a direct injection internal combustion engine having a plurality of combustion chambers, can be operated according to different operating modes or different partial operating modes. Hence there are a number of otto-cycle partial operating modes possible. The stoichiometric otto-cycle partial operating mode has a combustion air ratio or air/fuel ratio λ=1 and is spark ignited by an ignition device, wherein flame front combustion (FFV) sets in. The stoichiometric otto-cycle partial operating mode can be applied throughout the entire engine load and/or engine speed range. It is preferentially implemented over other partial operating modes in the high engine load or engine speed range.

A otto-cycle partial operating mode can be spark ignited even with excess air, and can thus be implemented with a combustion air ratio λ>1. This partial operating mode is also commonly referred to as the DES partial operating mode (Stratified Direct Injection), wherein a stratified, overall lean fuel/exhaust gas/air mixture is formed in the respective combustion chamber by multiple direct fuel injections. Due to its stratified composition, at least in an idealised system, each combustion chamber has two regions having different combustion air ratios λ. This stratification is typically generated through multiple fuel injections. First, a lean, homogeneous fuel/exhaust gas/air mixture may be introduced into the respective combustion chamber by one or more injections of fuel. Into this lean, homogeneous region, a fuel/air mixture that is richer than that in the lean, homogeneous region, is then positioned in the area of the ignition device through a final injection of fuel that can also take the form of multiple injections. This method is commonly referred to as HOS (Homogenous Stratified Mode). The overall lean fuel/exhaust gas/air mixture in the combustion chamber can be ignited and reacted through flame front combustion (FFV) by the richer fuel/air mixture in the area of the ignition device. The DES and HOS partial operating modes are preferred in the lower engine load and/or engine speed range.

The DES and HOS partial operating modes can also be compression ignited, but are then usually no longer referred to as DES or HOS partial operating modes.

The RZV partial operating mode can likewise be implemented at least at a lower engine load and/or engine speed range, wherein a lean, homogeneous fuel/exhaust gas/air mixture in the respective combustion chamber is ignited by controlled auto-ignition, and hence compression ignited. In contrast with an otto-cycle partial operating mode, wherein a flame front combustion (FFV) arises through spark ignition, with the RZV partial operating mode, the fuel/exhaust gas/air mixture in the respective combustion chamber ignites in multiple regions of the respective combustion chamber almost simultaneously so that controlled auto-ignition occurs. The RZV partial operating mode exhibits significantly lower NOx emissions compared to the otto-cycle partial operating mode, while at the same time being characterised by lower fuel consumption.

The NAV partial operating mode, which is the subject matter of the invention, can be thought of as being a combination of a spark-ignited, otto-cycle partial operating mode and an RZV partial operating mode. Thus, for the NAV partial operating mode there is a homogeneous, lean fuel/exhaust gas/air mixture that is spark ignited by means of an ignition device. With the NAV partial operating mode, following an initial flame front combustion (FFV), the combustion of the homogeneous fuel/exhaust gas/air mixture transitions to a controlled auto-ignition (RZV). As a result, the NAV partial operating mode exhibits lower fuel consumption and reduced NOx emissions when compared to the otto-cycle partial operating mode due to the controlled auto-ignition (RZV).

In contrast with the RZV partial operating mode, during the NAV partial operating mode combustion is spark ignited by an ignition device. For this reason, amongst others, operating stability of the mixture ignition and/or combustion is significantly improved, especially in the higher end of the engine load or engine speed range. Thus the homogeneous, lean fuel/exhaust gas/air mixture starts to combust with a kind of a otto-cycle flame front combustion (FFV) that then transitions into a controlled auto-ignition (RZV). In this way the NAV partial operating mode combines the advantages of controlled auto-ignition (RZV) with the spark-ignited, operationally stable ignition of the fuel/exhaust gas/air mixture. Implementation of the NAV partial operating mode that is the subject matter of the invention can thus be controlled by supplying an appropriate fuel/exhaust gas/air mixture to each combustion chamber, as well as by means of spark igniting at the correct time by means of an ignition device.

The NAV partial operating mode is characterised by a low pressure gradient and a reduced knocking tendency. As a result of this, the NAV partial operating mode makes controlled auto-ignition (RZV) feasible in a higher engine load range in which the pure RZV partial operating mode is no longer operationally stable enough due to the increasing pressure gradient and irregular combustion conditions, and in particular, because of the increased knocking tendency.

A comparison of the partial operating modes leads to the following conclusion:

| Partial operating | Fuel | NOₓ | | Engine |
|---|---|---|---|---|
| modes | consumption | emissions | Application | smoothness |
| otto-cycle | +/− | +/− | +++ | +/− |
| λ = 1 | | | | |
| DES | +++ | −− | + | +/− |
| RZV | ++ | +++ | + | +/− |
| NAV | ++ | ++ | ++ | ++ |

(− [symbol] deterioration, + [symbol] improvement, ++ [symbol] much improvement, +++ [symbol] very much improvement)

As a result, partial operating modes with controlled auto-ignition (RZV) exhibit both lower fuel consumption and reduced NOx emission values when compared with stoichiometric otto-cycle combustion systems. Moreover, through the NAV partial operating mode, the operating range can be extended to include the efficient controlled auto-ignition mode. With the NAV combustion method, engine smoothness is also improved when compared to the partial operating modes with compression ignition.

A lean fuel/exhaust gas/air mixture is a fuel/exhaust gas/air mixture that has a combustion air ratio of λ>1 and thus an excess of air, whereas a rich fuel/exhaust gas/air mixture has a combustion air ratio of λ≦1.

The combustion air ratio is a dimensionless physical quantity that is used to describe the composition of a fuel/exhaust gas/air mixture. The combustion air ratio λ is calculated as a quotient of the actual air mass available for combustion and the minimum stoichiometric air mass required for a complete combustion of the available fuel. Accordingly, if λ=1, one talks of a stoichiometric combustion air ratio or fuel/exhaust gas/air mixture, and when λ>1 of a lean air combustion ratio or fuel/exhaust gas/air mixture. Furthermore, if λ=1 or λ<1, one talks of a rich combustion air ratio or fuel/exhaust gas/air mixture.

In a preferred embodiment, for the NAV partial operating mode the combustion air ratio at the ignition point is 1≦λ≦2.

Furthermore, the composition of the fuel/exhaust gas/air mixture can be specified by the charge dilution. Regardless of whether there is a lean, rich or stoichiometric fuel/exhaust gas/air mixture, the charge dilution dictates how much fuel in relation to the other components of the fuel/exhaust gas/air mixture was introduced into the combustion chamber. The charge dilution is the ratio of the mass of fuel to the total mass of the fuel/exhaust gas/air mixture that is present in the respective combustion chamber.

In a preferred embodiment of the NAV partial operating mode, the charge dilution is set to between 0.03 and 0.05.

Because ignition timing plays a crucial role in the NAV partial operating mode, in a preferred embodiment the ignition point is set to occur at a crank angle (CA) of between −45° and −10°.

The crank angle (CA) is the position in degrees of the crankshaft in relation to the movement of the piston in the cylinder or combustion chamber. In the case of a four-stroke cycle, where an intake stroke is followed by a compression stroke, then an expansion stroke and subsequently an exhaust stroke, the top dead centre (TDC) position of the retracted piston in the respective combustion chamber or cylinder between the compression stroke and the expansion stroke is usually assigned a crank angle (CA) of 0°. Starting from this top dead centre position at 0° CA, the crank angle increases towards the expansion stroke and exhaust stroke and decreases towards the compression stroke and intake stroke. Using the described gradation system, the intake stroke occurs between −360° CA and −180° CA, the compression stroke between −180° CA and 0° CA, the expansion stroke between 0° CA and 180° CA and the exhaust stroke between 180° CA and 360° CA.

When a largely homogeneous, lean fuel/exhaust gas/air mixture is referred to, this is understood to be a homogeneous, lean fuel/exhaust gas/air mixture that is essentially uniformly distributed in the respective combustion chamber. In an ideal situation there is a completely homogeneous distribution. In a realistic scenario, however, small inhomogeneities can be present, but they have no significant impact on the respective partial operating mode. This type of homogenous, lean fuel/exhaust gas/air mixture can be produced by single or multi-point fuel injection. In a preferred embodiment the injections or multi-point injections of fuel are performed dependent on load and/or engine speed.

In a preferred embodiment, the respective partial operating mode is selected depending on the engine load and/or the engine speed. In an advantageous embodiment, the RZV partial operating mode or the DES partial operating mode can be implemented at a low engine load range while the NAV partial operating mode is implemented at middle and upper engine load ranges. Hence the RZV partial operating mode and the DES partial operating mode can be used in about the same engine load range while at higher engine load ranges it can be switched from a RZV partial operating mode to the NAV partial operating mode and/or from a DES partial operating mode to the NAV partial operating. Thus with the NAV partial operating mode, a combustion process is also realisable at medium load ranges with correspondingly low NOₓ emissions and reduced fuel consumption.

To improve knocking tendency and the operational stability of the NAV partial operating mode, the compression ratio ε is lowered or raised when switching from a RZV partial operating mode and/or DES partial operating mode to the NAV partial operating mode or vice versa. As a result of the lower compression ratio ε, the knocking tendency is significantly reduced, and an earlier centre of combustion, as well as a resultant increase in operational stability for the NAV partial operating mode, is effected.

A compression ratio ε refers to the ratio of the entire combustion chamber prior to compression and space remaining after compression. Accordingly, the compression ratio ε is computed as the quotient of the compression volume and the sum of piston displacement and compression volume.

In a preferred embodiment, the NAV partial operating mode is implemented with a compression ratio ε of between 10 and 13. In a preferred embodiment, the RZV partial operating mode is implemented with a compression ratio ε of between 10 and 15. In a preferred embodiment, the DES partial operating mode is implemented with a compression ratio ε of between 10 and 15.

The aforementioned compression ratios describe the preferred ranges. All of the combustion processes mentioned here can, however, also be realised at lower or higher compression ratios.

In a preferred embodiment, a switch between the RZV partial operating mode and the NAV partial operating mode is undertaken at an engine speed of between 5% and 70% of the maximum engine speed and/or at an engine load of between 5% and 30% of the maximum motor load. In a preferred embodiment, a switch between the DES partial operating mode and the NAV partial operating mode is likewise undertaken at an engine speed of between 5% and 70% of the maximum engine speed and/or at an engine load of between 5% and 30% of the maximum engine load.

At higher engine loads that lie outside the operating range of the NAV partial operating mode, switching between the NAV partial operating mode and a spark ignited, otto-cycle partial operating mode with a combustion air ratio of λ=1 is possible. The compression ratio ε can be further lowered when such a switch is made towards the upper limit of the load range in otto-cycle partial operating mode. Thus the otto-cycle partial operating mode operates with a lower compression ratio ε than the NAV partial operating mode leading to improvements in knocking tendency and operational stability for the otto-cycle partial operating mode.

Further important features and advantages of the invention arise from the dependent claims, from the diagrams and from the descriptions based on the diagrams.

It is understood that the features that are mentioned above and those still to be described in the following can be used not only in the combination specified in each case, but also in other combinations or individually, without exceeding the scope of the present invention.

### BRIEF DESCRIPTION OF THE DRAWINGS

Preferred exemplary embodiments of the invention are illustrated in the figures and explained in more detail in the description below, wherein the same reference numerals refer to the same or similar or functionally identical components.

FIG. 1: a graphical representation of a combustion curve of the NAV operating mode,

FIG. 2: a comparison of valve lift heights of an RZV, NAV, and DES operating mode,

FIG. 3: a graphical representation of an engine characteristics map of the RZV and NAV operating modes,

FIG. 4: setting conditions of the RZV and NAV operating mode,

### DETAILED DESCRIPTION OF THE PARTICULAR EMBODIMENTS

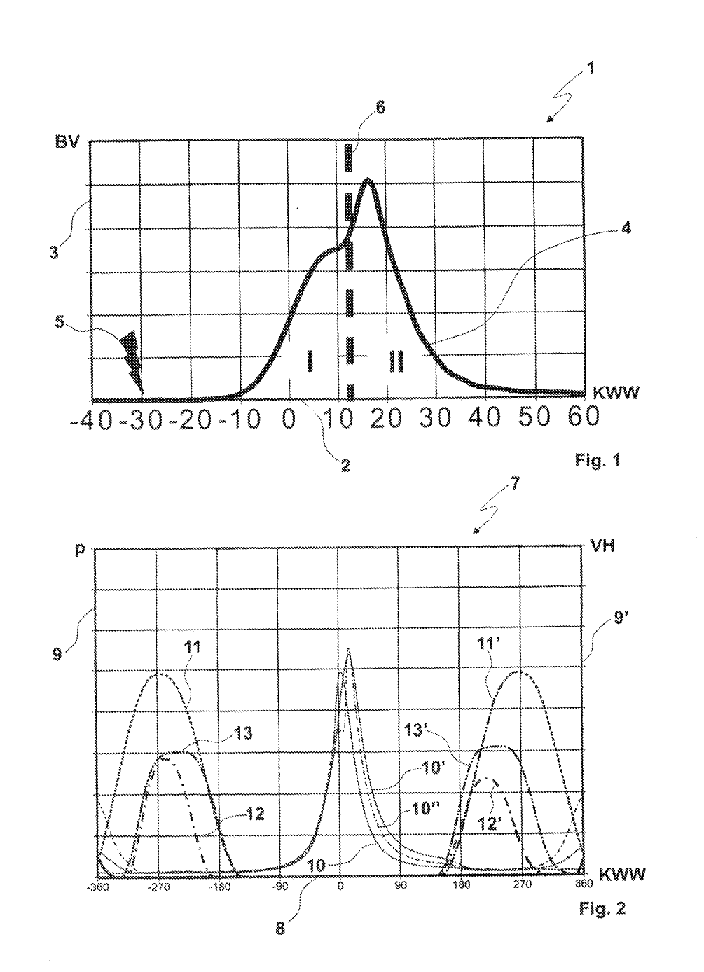

FIG. 1 shows a combustion curve diagram 1 of a NAV partial operating mode, where the crank angle CA is plotted along the X-axis 2 in degrees and where a combustion curve is plotted up the Y-axis 3 in Joules. The combustion process of the NAV partial operating mode is represented by a curve 4. A fuel/exhaust gas/air mixture introduced into the respective combustion chamber is spark ignited at an ignition point 5 and at a crank angle of −30°+/−5° CA. Up to a boundary line 6 the fuel/exhaust gas/air mixture introduced into the respective combustion chamber burns with a otto-cycle flame front combustion (FFV). From boundary line 6, the fuel/exhaust gas/air mixture, having become further heated and subjected to increased pressure by the flame front combustion (FFV), begins to transition to a controlled auto-ignition (RZV). A sufficiently high pressure and temperature required for compression ignition are built up by the advancing flame front combustion (FFV). In this way the NAV partial operating mode can be divided into a phase I having homogeneous flame front combustion (FFV) and a phase II having controlled auto-ignition (RZV), wherein both phases I, II are separated by the boundary line 6.

FIG. 2 shows a cylinder pressure/valve lift diagram 7, wherein the crank angle CA is plotted along the X-axis 8 in degrees and wherein the cylinder pressure P in bar and the valve lift VH in millimetres is plotted up the Y-axis 9, 9′. The curves 10, 10′, 10″ reference the cylinder pressure curves of the DES, RZV and NAV partial operating modes respectively. The cylinder pressure gradation of the Y-axis 9 applies to these curves. Furthermore, the DES valve lift curves 11, 11′ the RZV valve lift curves 12, 12′ and the NAV valve lift curves 13, 13′ are plotted on the cylinder pressure/valve lift diagram 7. On comparing the valve lift curves 11, 11′, 12, 12′, 13, 13′ one notices that the NAV valve lift curves 13, 13′ are considerably smaller than the DES valve lift curves 11, 11′. The DES valve lift curves 11, 11′ also span a larger range of crank angles than the NAV valve lift curves 13, 13′. As a result, exhaust gas retention or an internal exhaust gas recirculation is hardly possible with this type of DES valve lift curve 11, 11′. In contrast to this, NAV valve lift curves such as this mean that an internal exhaust gas recirculation and/or an exhaust gas retention can be implemented.

If one now compares the RZV valve lift curves 12, 12′ and the NAV valve lift curves 13, 13′, one finds that the NAV valve lift curves 13, 13′ exhibit a slightly greater valve lift and moreover, they span a wider range of crank angles than the RZV valve lift curves 12, 12′. Consequently, such RZV valve lift curves 12, 12′ are characterised by a larger exhaust retention or internal exhaust gas recirculation, and allow as a result higher temperatures to be set in the combustion chamber. Due to the small amount of lift and short opening times, however, the air flow is greatly restricted. Consequently, such RZV valve lift curves 12, 12′ are of only limited use for a high engine load range. This is improved with the illustrated NAV valve lift curves 13, 13′, since on the one hand higher valve lifts can be set, and on the other the valve remains open through a wider range of crank angles. Thus using such NAV valve lift curves as 13, 13′ allows a lower temperature in the particular combustion chamber to be set, and the intake air volume is greater than with the RZV valve lift curves 12. 12′ illustrated in FIG. 2.

FIG. 3 shows an engine load/engine speed diagram 14, wherein an engine characteristics map 15 for the RZV partial operating mode/DES partial operating mode and an engine characteristics map 16 for the NAV partial operating mode are plotted. In the engine load/engine speed diagram 14, the engine speed is plotted along the X-axis 17 while the engine load is plotted up the Y-axis 18. A boundary curve 19 delimits the engine load and engine speed range within which the internal combustion engine can be operated. In the engine load/engine speed range 20, which is not encompassed by the engine characteristics map 15 for the RZV partial operating mode/DES partial operating mode or by the engine characteristics map 16 of the NAV partial operating mode, an otto-cycle partial operating mode can be implemented.

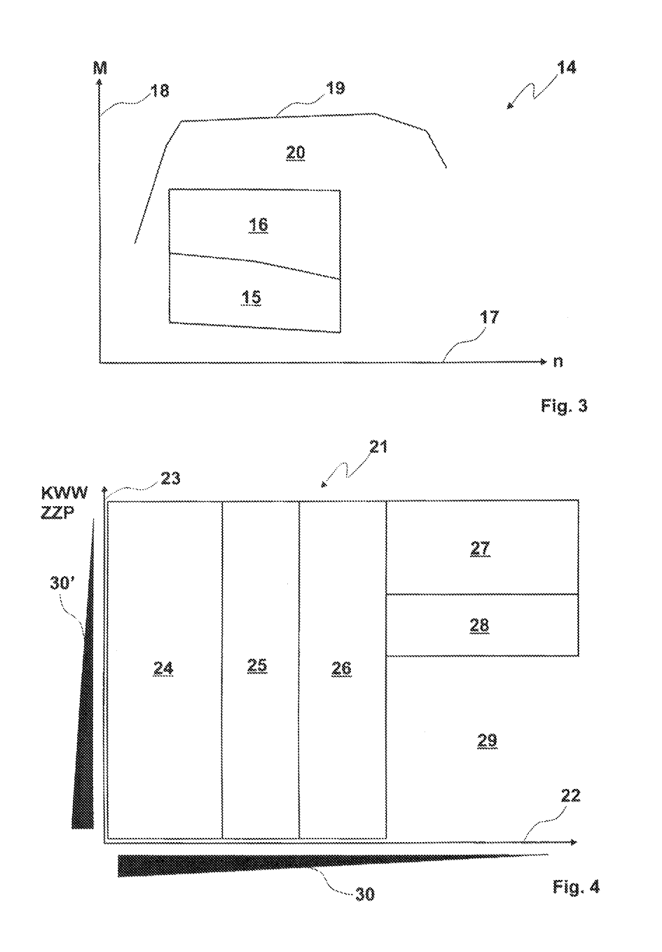

A setting conditions diagram 21 shown in FIG. 4 schematically illustrates setting conditions for the RZV partial operating mode and for the NAV partial operating mode. The charge dilution is plotted along an X-axis 22 that decreases in the direction of the X-axis 22 as illustrated by a tapered bar 30. Correspondingly, the engine load increases along the X-axis 22. The crank angle (CA) at the ignition point (ZZP) is plotted up a Y-axis 23, said crank angle likewise decreasing in the direction of Y-axis 23 as illustrated by a tapered bar 30′. The operating ranges 24, 25, 26, 27, 28, 29 are mapped in the settings condition diagram 21. The operating range 24 indicates a possible operating range for the RZV partial operating mode. In this very high charge dilution range it is not possible to spark ignite the correspondingly dilute fuel/exhaust gas/air mixture with an ignition device. The RZV partial operating mode can be advantageously implemented in said operating range 24. With decreasing charge dilution, both the RZV partial operating mode as well as the NAV partial operating mode can be advantageously implemented in operating range 25. By using the NAV partial operating mode, the centre of combustion can be shifted to occur at an earlier crank angle by means of the ignition timing.

If one further lowers the charge dilution, one enters the operating range 26. While it is possible to implement the RZV partial operating mode in operating range 26, in this charge dilution range, the RZV partial operating mode exhibits an increased knocking tendency and is characterised by a correspondingly large increase in pressure. Thus the RZV partial operating mode in this charge dilution range suffers from increased operating instability that can, by way of example, be mitigated through external exhaust gas recirculation. This operating range 26 can be bypassed by the NAV partial operating mode, wherein the centre of combustion can in this case likewise be shifted to occur at a lower crank angle by the appropriate choice of ignition timing (ZZP).

The NAV partial operating mode is preferentially implemented in the operating range 27. An otto-cycle partial operating mode can be implemented in the operating range 28. It is usually not possible to implement the RZV, NAV or DES partial operating modes in the operating range 29.

What is claimed is:

1. Operating mode for an, in particular direct-injection, internal combustion engine with exhaust gas recirculation, in particular for a direct injection gasoline engine, comprising:
wherein a RZV partial operating mode is implemented in a region of the engine characteristics map having low to medium speed and/or low to medium load, said RZV partial operating mode having a lean fuel/exhaust gas/air mixture that is ignited by compression ignition and combusts by controlled auto-ignition (RZV),
wherein the region of the engine characteristics map with compression ignition is bordered at higher load by another region of the engine characteristics map in which low-NOx combustion (NAV) is performed,
wherein at an ignition point (ZZP) a homogeneous, lean fuel/exhaust gas/air mixture with combustion air ratio λ≧1 in a given combustion chamber of the internal combustion engine is spark ignited by means of an ignition device,
wherein a flame front combustion (FFV) initiated by the spark ignition transitions to controlled auto-ignition (RZV),
wherein it is switched between at least one other partial operating mode and a NAV partial operating mode wherein a change in the compression ratio ε is undertaken when switching from on partial operating mode to another partial operating mode.

2. Operating mode according to claim 1, wherein the respective partial operating mode is selected depending on the engine load and/or the engine speed.

3. Operating mode according to claim 1 wherein at least one switch selected from the following set is performed:
a switch between the RZV partial operating mode having pure controlled auto-ignition (RZV) and the NAV partial operating mode,
a switch between a spark ignited, stratified DES partial operating mode (stratified direct injection) and the NAV partial operating mode,
a switch between the RZV partial operating mode and an HOS partial operating mode (stratified homogeneous mode),
a switch between the NAV partial operating mode and the HOS partial operating mode,
a switch between the DES partial operating mode and the HOS partial operating mode.

4. Operating mode according to claim 1, wherein when changing to the NAV partial operating mode, the compression ratio ε is lowered.

5. Operating mode according to claim 1, wherein the NAV partial operating mode is implemented with a compression ratio ε between 10 and 13 and/or the HCCI partial operating mode is implemented with a compression ratio ε between 10 and 15 and the DES partial operating mode is implemented with a compression ratio ε between 10 and 15.

6. Operating mode according to claim 1, wherein a switch between the RZV partial operating mode and the NAV partial operating mode is undertaken at an engine speed of between 5% and 70% of the maximum engine speed and/or at an engine load of between 5% and 30% of the maximum motor load and/or a switch between the DES partial operating mode and the NAV partial operating mode is undertaken at an engine speed of between 5% and 70% of the maximum engine speed and/or at an engine load of between 5% and 30% of the maximum motor load.

7. Operating mode according to claim 1, wherein at higher engine loads, switching occurs between the NAV partial operating mode and a spark ignited, SI partial operating mode with a combustion air ratio of λ=1.

8. Operating mode according to claim 7, wherein at regions approaching full load, the compression ratio λ is further lowered in the SI operating mode with a combustion air ratio of λ=1.
